(19) United States
(12) Patent Application Publication
(10) Pub. No.: US 2003/0048759 A1
(43) Pub. Date: Mar. 13, 2003

(54) Configurating device for an electronic module, and a network having a multiplex bus with several lines

(76) Inventor: Herve Cara, Bobigny Cedex (FR)

Correspondence Address: MORGAN & FINNEGAN, L.L.P., 345 PARK AVENUE, NEW YORK, NY, 10154, US

(21) Appl. No.: 10/229,417

(22) Filed: Aug. 27, 2002

(30) Foreign Application Priority Data
Aug. 30, 2001 (FR) 0111397

(51) Int. Cl. H04B 1/44

(52) U.S. Cl. 370/282

(57) ABSTRACT

A network has a multiplexed bus with a plurality of lines on which several electronic modules are disposed. Each module has a configurating device. Each module includes a connector such that a bus line may be connected to at least one of several terminals of the connector which are reserved to it. Detection of the terminals connected to this bus line ensure coding of a unique address for each of the modules in the network.

### FIELD OF THE INVENTION

The present invention relates to a device for configuring an electronic module. It also relates to a network with a multiplexed bus consisting of a plurality of lines on which are disposed a plurality of electronic modules, each of which is equipped with one of these configurating, or configuration, devices.

### BACKGROUND OF THE INVENTION

In the current state of the art, it is known to provide networks of electronic modules which are connected to each other, and often to a central station through a bus which comprises a plurality of lines for carrying signals and/or power supply voltage. This is particularly the case in respect of electronic modules which are dedicated to the control of electrical actuators in a vehicle having an on-board computer. Examples include electrical door locking systems, headlight orienting equipment, and so on.

In such a network, the bus comprises a conductor for transmitting a positive electrical voltage derived from the battery of the vehicle, together with an electrical ground (earth) conductor and one or more conductors for passing digital messages, directly or in the form of modulated signals in accordance with a protocol which is predetermined to be such that over time, a succession of messages transmitting orders from the bus controller or master electronic module are attributed to a predetermined one of the electronic modules, which can itself pass back completion messages, or messages as to its state, to the bus controller or master electronic module. In response to these exchanges, the electronic module performs the tasks for which it is programmed, for example starting or stopping of an electrical actuator which is connected to it, and also local protection functions for the actuator, such as, in particular, the control of electronic operating parameters.

In order to exchange messages on the network, each electronic module must receive a name that identifies it in the network.

In the current state of the known art, numerous solutions have been proposed for attributing, for example during the connection of the electronic module to the network, a unique code which permits an electronic module to insert itself into the protocol of communication on the network.

In particular, a first technique is known according to which a first mechanical locating element is mounted on the electronic module in such a way that mounting of the module is possible only at a specific location provided on the network. The first locating element may be mounted on a first connector, for example a female connector, which is fixed with respect to the electronic module. A second mechanical locating element, reciprocal to the first locating element, is mounted on the second connector, which is for example a male plug, and is connected to the free end of a bundle of conductors, the other end of which is connected electrically to the network. The second connector or plug enables the electronic module to be connected to the network. The first and second locating elements are so configured that, among all of the modules which have been arranged for connection on the network, only one of them will connect to the second connector. The address of the electronic module is therefore determined in a manner set by its position of connection in the network.

In another known system in the current state of the art, the addressing of a module is performed by the conductors of the bundle which are reserved to an address function. Let us say that the bus has p wires reserved for addressing 2p modules if the address coding is of the binary type. An address decoding circuit disposed on the electronic module, for reading the p terminals of the first connector fixed to the module (these terminals being connected to the p address lines of the bus), enables the address attributed by the network to the electronic module to be known at any instant, and therefore enables the modules to be distinguished from each other.

In a further system known in the current state of the art, the addressing of an electronic module is performed with the aid of electrical resistances, which are connected between the positive supply the electrical ground (or earth) that are provided by the bus, together with a circuit for measuring currents passing through the resistances. In operation, this measuring circuit produces measurement signals which depend on the values of the resistances, and it is therefore possible, by making an appropriate choice of these values, to code each electronic module in the network uniquely and to be able to identify it at any moment.

Finally, in yet another system known in the state of the art, the addressing of an electronic module is obtained by a programming method which consists in writing an identification numeral (ID code) in a register which can be written in once, for example during manufacture or during connection of the electronic module on the network, so that the electronic module is always recognised by the ID code in the network and its protocol.

The disadvantages of these various known systems lie in the fixed character of the identification of each module for the most mechanical solutions, and, for the solutions which are the most electronic, in the complexity of the addressing procedure which is generally undergone by a unit for generating the protocol, and/or in the complexity of the network for designating such an address procedure adaptively.

### DISCUSSION OF THE INVENTION

An object of the present invention is to provide a remedy to the various disadvantages discussed above.

According to the invention in a first aspect, a configuration device for an electronic module, in a network of the kind comprising a multiplexed bus having several lines, is characterised in that it comprises:

a connector including, for at least one line of the multiplexed bus, a predetermined number of terminals, whereof only one subset is connected to the said line;

a circuit for reconstituting the line connected to the said terminal subset, and for connecting it to the remainder of the module;

a circuit for detecting the relative positions of the terminals connected in the said terminal subset; and

an identification (ID) generator which is a circuit for generating a unique digital item of data, on the basis of the detection of the relative positions of the connected terminals, the said data item identifying the electronic module.

According to the invention in a second aspect, a network with a multiplexed bus of several lines is characterised in that it comprises a plurality of electronic modules, each of which includes a configuration device according to the said first aspect of the invention, and the said bus has a redundancy of lines such that the address of each electronic module is defined by the pattern of connection of the electronic module to the bus of the network, the said address being recognised locally by the configuration circuit of the electronic module.

The network of the invention includes a plurality of electronic modules, each electronic module having a configuration device in accordance with the invention. Further features and advantages of the present invention will appear more clearly on a reading of the following detailed description of some preferred

embodiments of the invention, which are given by way of non-limiting example only and with reference to the accompanying drawings.

### BRIEF DESCRIPTION OF THE DRAWINGS

FIGS. 1 to 3 show parts of a system in a first version in the current state of the art.

FIG. 4 shows part of a system in a second version, again in the current state of the art.

FIG. 5 is a block diagram illustrating one particular preferred embodiment of a configurating device in accordance with the invention.

FIG. 6 is a block diagram illustrating one particular embodiment of a multiplexed bus network with a plurality of lines in accordance with the invention.

FIG. 7 is a block diagram illustrating a further version of part of a network according to the invention.

FIGS. 8 and 9 show one particular embodiment of a circuit for the configurating device of the invention.

FIGS. 10 and 11 are two views of an assembly showing one embodiment of a part of the invention.

### DESCRIPTION OF PRIOR ART ARRANGEMENTS

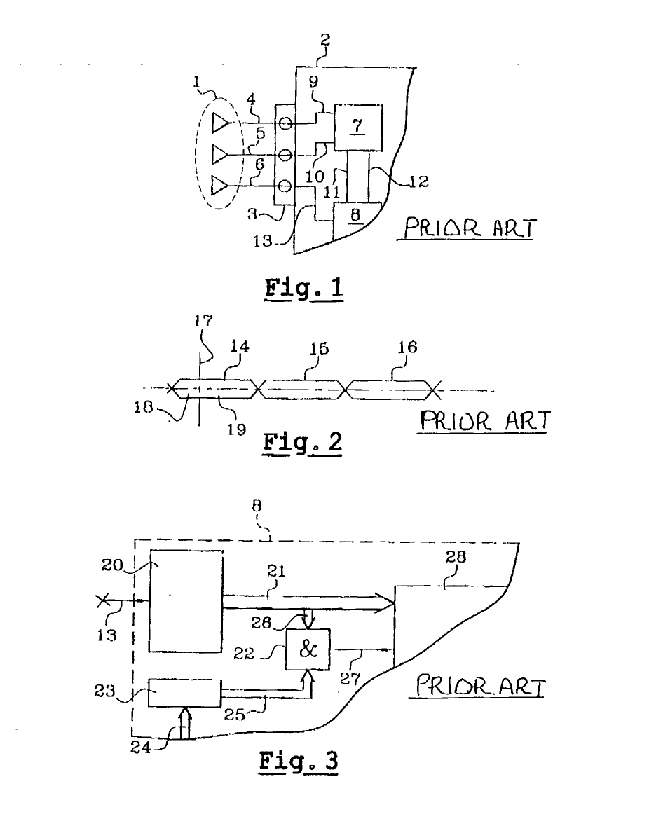

Reference is first made to FIGS. 1 to 3 showing a first known embodiment. A network includes a multiplexed bus which comprises a bundle 1 consisting, in this example, of three lines for signals and power supply voltages for the network. These are, respectively:

a line 4 which is at a positive dc supply voltage;

a line 5 which is at a negative dc power supply voltage; and

a line 6 which consists of one or more digital signal lines multiplexed over time in accordance with a particular protocol.

The bundle 1 is connected electrically to a connector 3 which is part of an electronic module 2 connected to the network through the bundle 1. The electronic module 2 comprises a circuit 7 for generating a unidirectional polarisation voltage destined for the other electronic and electrical circuits of the module 2. The polarisation voltage generating circuit 7 is connected through lines 9 and 10 to the terminals of the connector 3 which are connected electrically to the lines 4 and 5 of the bundle 1. Output lines 11 and 12 of the circuit 7 are arranged to transmit the appropriate electrical polarisation to a circuit 8 incorporated in the module 2.

The circuit 8 is a circuit for making use of information signals which are taken on the connector 3 by the line 13 which puts the information signals on the user circuit 8.

FIG. 2 shows diagrammatically the configuration of the signals passed on the multiplexed bus on which the bundle 1 is connected. The time diagram of the signals represented by FIG. 2 comprises a plurality of frames or fields 14, 15 and 16 having a predetermined period. Each frame is divided into two parts at an instant 17, determined with respect to the commencement of the frame, such that a first part 18 of the frame contains an item of data identifying the electronic module connected to the network, which module is the addressee of the message 19 coming from the network or emitter of the electronic module 2. The division of the frames is repeated from frame to frame.

The code contained in the first or identification (ID) part of the frame 18 may comprise the address of a subset of electronic modules. The message contained in the message part 19 may comprise orders to control electromagnetic devices such as actuators which are controlled by the electronic module that receives the message contained in the frame 14.

Reference is now made to FIG. 3 of the accompanying drawings, which shows diagrammatically a prior art circuit for detecting the code of a message of an identification (ID) number for the module 2.

The electronic module is connected to a line 13 through an input terminal of a frame dividing circuit 20 which separates the frame 14 (FIG. 2) into its two parts, the ID part 18 and the message part 19. These two parts are transmitted in succession on an internal output bus 21 to the module 2.

The first part 18 of the message is taken from the internal bus 21 by a bus 26 which is connected to a first input of a comparator 22, which has a second input connected through an internal bus 25 to a register 23. The register 23 contains a unique ID number for the electronic module 2.

The ID number held in the register 23 is compared with the data item presented at the first input 26 of the comparator 22, so that when the two inputs coincide, a signal is activated at the output 27 of the comparator 22. The comparator 22 is connected to a user circuit 28, which also receives the frame 14, through the bus 21. As a result, the module 2 is able to know that it is the addressee of the message 19 contained in the frame 14. The mechanism can also work in an emitter mode, and will not be described here any further.

However, it will be noted that the register 23 must receive, through a writing or registering mechanism and via a writing bus 24, the ID code for the module 2. Such a mechanism adds to the technical problems in the design of networks for communication on a multiplexed bus, and the present invention aims to resolve this problem.

Another known arrangement is shown in FIG. 4, to which reference is now made. In FIG. 4, the multiplex bus 30 comprises a plurality of signal and supply voltage lines which, in the version shown in FIG. 4, are as follows:

lines 31 and 32 carrying a positive supply voltage and electrical ground or earth, these lines being adapted to generate local electrical polarisations for the electronic modules connected to the network; and

signal lines 33, 34 and 35, each of which is reserved for a plurality of particular modules.

In this arrangement, each module 38, 46, 48 carries a female connector, which is given the reference numeral 37 for the electronic module 38 and which is matched uniquely to a male connector 36, which is connected to the bus 30 by suitable wires in a bundle. The connector 36 is only able to be connected on the single connector 37 of the module 38. In this connection, the female connector 37, like the other female connectors 45 and 47 shown, has a plurality of terminals 39, 41 and 43 respectively, which are disposed facing corresponding terminals 40, 42 and 44 of the male connector 36 of the module 38, so defining a first geometrical pattern.

The male connector (not given a reference numeral) which is associated with the electronic module 46 has a different geometric pattern of its terminals, 49 to 51 respectively. It will be noted that the geometrical pattern of the terminals of the pair of connectors 36 and 37 is incompatible with the geometrical pattern of the terminals in the other pairs of connectors. As a result, it is impossible to connect the module 46 on the female connector 36 or the female connector 47, and the same is true for the other modules.

Consequently, the module 38 is always perfectly recognised in the connection to the bus 30, especially if the signal is destined essentially for the module 38 by reservation of the line 33 for the module 38, the line 34 for the module 46, and the line 35 for the module 48. However, it is found that this situation does not permit any connection of a large number of electronic modules on a common bus. This is a further problem that the present invention aims to resolve.

### DESCRIPTION OF SOME PREFERRED EMBODIMENTS OF THE INVENTION

The above description of the prior art arrangements will enable the remainder of this description to be understood more easily.

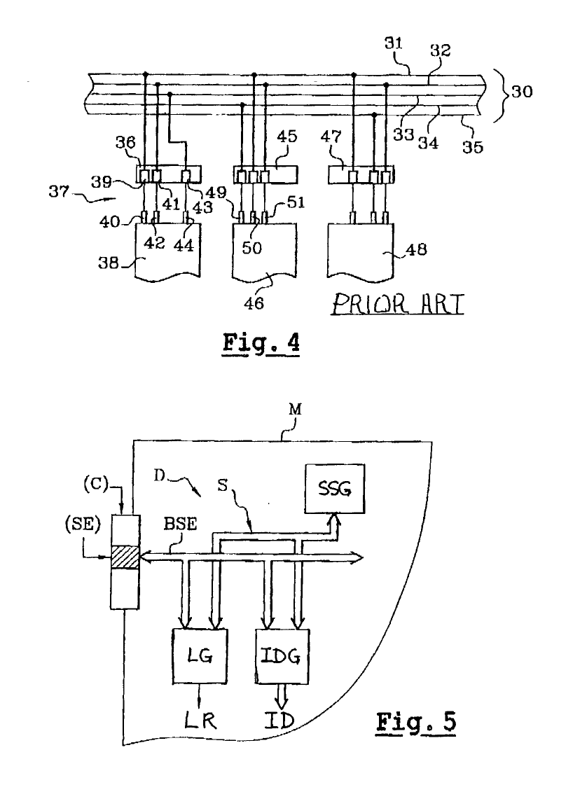

Reference is now made to FIG. 5, which shows one preferred embodiment of a configuring device which is arranged to adapt itself to electronic modules so as to constitute a network according to the present invention.

Each electronic module M for the network comprises a device of configuration D which is connected to a connector C having a plurality of terminals arranged for connection to the wires or lines of the bus of the network on which the electronic module is to be connected.

A subset SE of terminals of the connector C is reserved for connection of one particular line of the bus in the network concerned. It should be noticed, by way of difference between the invention and the prior art, that a single terminal is provided for each bus line. As a result, in the arrangement according to the invention, there are in each bus line several possibilities for connection on each of p terminals of the subset SE of terminals on the connector C. The p terminals may not all be contiguous on the connector C. In the same way, each bus line, or only some of the bus lines, may be attributable to one particular subset of terminals on the connector C.

Each subset of terminals SE reserved to a particular line is connected through an internal bus of each electronic module M, the bus being indicated at BSE in FIG. 5, in such a way that the signals are distributed, respectively, to a line generator LG, comprising a circuit for reconstituting lines, and to an ID generator IDG, for generating identification parameters, also referred to herein as identifiers (ID).

The configuring device also includes a selection signal generator SSG which is connected through a selection bus S to the appropriate inputs of the line generator LG on the one hand and the ID generator IDG on the other.

The line generator LG enables the bus line which is connected to the terminal subset SE of the connector C to be transmitted to the rest of the module in the form of a single reconstitution line LR, shown in FIG. 5 at the output of the line reconstitution circuit LG.

In one embodiment, the circuit LG consists of a circuit in which N inputs which are all at the same potential or at a floating potential are reassembled in a single output line. Such a reassembly of identical lines or of lines put at a floating potential is performed with a combination, or combining, circuit having diodes to protect the inputs.

The ID generator circuit LDG in the configuring device D of the electronic module M also includes a circuit for detecting the terminals connected in the terminal subset SE of the connector C, in such a way that a unique ID number ID is generated.

In order to carry out such a function, the configurating device further includes the selection signal generator SSG, or selection order generator, which sequentially interrogates each terminal of the terminal subset SE. The ID generator IDG includes means for detecting which terminal is really connected to the line corresponding to the bus on the subset SE of the connector C.

To this end, the selection signal generator SSG includes means for scanning the various input terminals of the subset SE, by placing successively each of the lines of the internal bus BSE connected to the terminal subset, at a reference potential in order to be able to detect whether the terminal is really connected to the bus line or not. This results in a succession of logic signals, with a value TRUE if the interrogated terminal is connected to the bus line, or the value FALSE if the interrogated terminal is not connected. The succession of the logic signals for detecting relative positions of the terminals connected in the terminal sub-assembly SE is used by the circuit in order to generate a unique digital signal, or data item, identifying the electronic module.

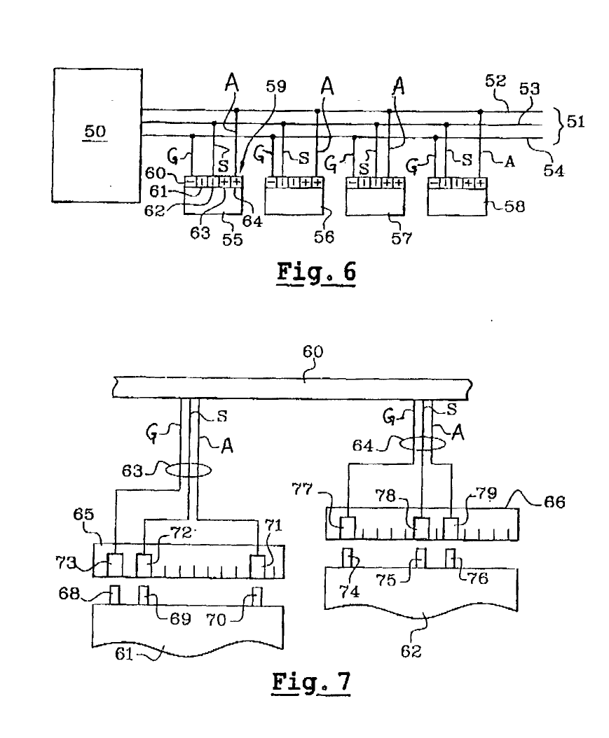

Reference will now be made to FIG. 6, which shows one particular version of a multiplex bus network with several lines, and which includes electronic modules, four in this example, each of which includes a configuring device which is generally of the kind described above with reference to FIG. 5. In this connection, the network includes a master unit 50 from which there stems a bus 51 consisting of three lines, namely a positive voltage supply line 52, a ground or earth line 54, and a signal line 53. The line 53 may be a single line on which one particular modulation is transmitted, or a plurality of signal lines.

Each electronic module 55 to 58 includes a connector such as the multi-pin plug 59 for the module 55. This plug has three subsets of connecting terminals, namely terminals 60 for a first subset which is connected through a line G to the earth line 54, and the terminals 61 and 62 which constitute a second subset and are arranged to be connected through a line S to the signal lines 53, together with a terminal 63 and 64 which constitute a third subset of terminals arranged to be connected, via at least one positive supply line A, to the positive supply line 52 of the bus 51.

Each of the four modules has a plug of the same type, which enables indexing means or special connectors, such as are used in the state of the art as shown in FIG. 4, to be avoided.

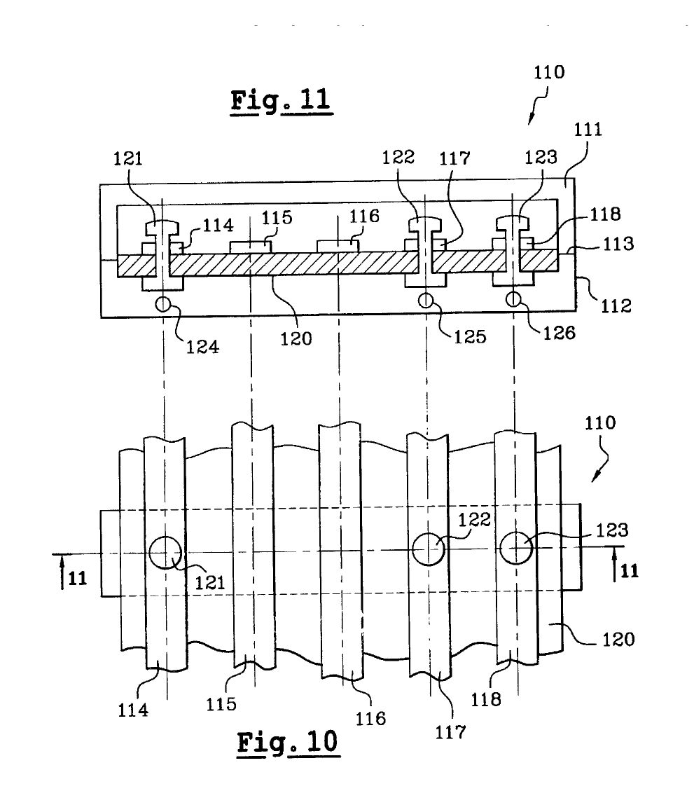

Reference should now be made to FIGS. 10 and 11, which show a version of a connector mounted on a flexible circuit on which the bus of the network is disposed. FIG. 10 is a front view in partial cross section, while FIG. 11 is a partial top plan view.

In this embodiment of the invention, the network bus consists of five conductive tracks 114 to 118, consisting of a thin layer of a conductive alloy deposited on a flexible insulating substrate 120, which is made of a polymeric material such as a polyimide. The flexible circuit can, at any point on its development, be associated with a connector 110 which consists of two parts, namely a lower part 112 and an upper part 111, which surround the flexible circuit 120, 114 to 118, each in the manner of a stirrup. The two parts 111 and 112 are joined together by a connection 113, which may for example be a snap-fitting connection.

In the version shown in FIGS. 10 and 11, the network is of the three-wire type, in which, in accordance with the present invention, two wires are demultiplied in such a way that:

the tracks 114 and 115 are positive polarisation wires, at the positive battery voltage, both of them being connected to the appropriate terminal of the power generating means, which is typically the battery of the vehicle where the system is installed on a vehicle;

the tracks 116 and 117 are signal lines connected to the signal exchange terminal of the control network for the onboard network of the vehicle; and

the track 118 is a ground (earth) wire connected to the ground terminal of the power generating means, such as the battery of a vehicle.

In practice, according to the identification of the module to which the connector 110 is to be associated, only three of the five bus wires 120, 114 to 118 must be connected to three suitable terminals of the electronic module (not shown in FIG. 10) with which the connector 110 is associated. Accordingly, there are four possibilities for connection of four modules, these possibilities being described in the following table, in which the modules are numbered #1 to #4 in four columns. In each column, an “x” indicates which of the five lines of the bus, listed in the left hand column, that particular module is connected to.

| Identification of the module | #1 | #2 | #3 | #4 |
|---|---|---|---|---|
| ′114 | x | | x | |
| ′115 | | x | | x |
| ′116 | x | x | | |
| ′117 | | | x | x |
| ′118 | x | x | x | x |

In this embodiment, the configuration circuit of each of the electronic modules #1 to #4 comprises a circuit for detecting which line or terminal is connected to the lines '114, '115, '116, '117 or '118, given that a single line or terminal of one polarity (or one type of signal if there are several kinds on the bus) is connected to the electronic module.

In order to increase the number of modules that can be connected in the network with a unique address, the invention, as will be described later herein, also, in another version not shown here, enables the number of terminals which are connected to a common potential or to a common type of signal, to be detected. As a result, in the diagrams of FIGS. 10 and 11, the connection of a single connector 110 through two appropriate terminals to the lines '114 and '115 is differentiated by the configuration circuit of the connection to only one of these two lines, which, in this case, increases the number of cases to nine electronic modules, #1 to #9.

In general, the network of the invention includes a bus controller, a multi-line bus, and at least one electronic module equipped with a configuration circuit. The bus has a redundancy of lines such that the address of each electronic module is defined by the pattern of connection of the electronic module to the bus of the network. The address is then recognised locally by the configuration circuit of the electronic module.

In order to connect any one electronic module (not shown in FIG. 10) electrically to its connector 110, and more particularly the configuration circuit with which that module is equipped, and in a manner known per se, three rivets of the eyelet type, 121 to 123, are used. Each of these is in two substantially cylindrical and coaxial parts (not shown), which are forced together through a hole which is for example (though not necessarily) formed during fitting of the connector 110, through the flexible bus circuit 120, 114 to 118. Each cylindrical portion of a rivet is terminated by a head which is shown in FIG. 11, so that once the two parts of the rivet are joined together on either side of the flexible circuit, the two cylindrical parts of each rivet constitute an integral electrically conductive part which makes electrical connection with the corresponding conductive track 114 to 118.

Finally, an electrical connection (not shown) is provided between the conductive end of a flexible wire (not shown) and each of the rivets 121 to 123. In a manner known per se, the wire is brought through passages 124 to 126 to the electronic module associated with the connector 110, and more particularly to the configuration circuit of that module, so as to enable it to be addressed uniquely by the on-board network.

Reference is now once more made to FIG. 6. In a further embodiment, each terminal 60 to 64 of the plug 59 is connected directly to a conductive line G, S or A. The positive supply line A may be connected to either one of the terminals 3 and 4, which gives two possible connections different from each other. Similarly, the signal line S may be connected to either the terminal 62 or the terminal 61, thus introducing two further possibilities.

Thus, by increasing the number of cases for possible connection of the lines A and S, the line G being always connected to the first terminal on the left of each of the plugs in the Figure, it will be seen that four electronic modules may be uniquely connected to the three-wire bus and recognised separately and distinctly by the master unit 50.

When it is required to increase the capacity of the network in which the electronic modules are to be connected, an increase will be made in:

the number of terminals of each subset of terminals attributed to a common line of the bus; or

the number of lines of the bus which correspond with distinct subsets of terminals for connection to the modules.

In another embodiment, a third means for increasing the capacity of the network to which the electronic modules are to be connected is added, according to which a plurality of homologous terminals of a common subset may be connected at the same time to the same signal line. This results in a consequential increase of the potential number of electronic modules to be connected to the same network.

It is clear that the configurating device of each of the electronic modules is made in accordance with the arrangements shown in FIG. 5. In the version shown in FIG. 5, only one terminal subset SE has been provided. In other cases, as in FIG. 6, two or more subsets of terminals are provided. The means of the configuration device which have been described are repeated simply for each of the subsets of terminals analysed. In particular, a general identification parameter generator (ID generator) consists of a logical combination of the various ID generators for each of the subsets, so as for example to construct, using an OR logic, a binary word representing uniquely the address of the electronic module in the network.

Reference is now made to FIG. 7, showing a modified version in which each electronic module 61 or 62 in the network includes a male connector consisting of three terminals 68, 69 and 70 for the module 61, and three terminals 74, 75 and 76 for the module 62.

The three-wire bus 60 has branch bundles 63 and 64 respectively, each of which is terminated at its free end by a female connector 65 for the bundle 63, and 66 for the bundle 64. Each bundle 63 or 64 contains the same signals G, S and A described above with refrence to FIG. 6.

The female connector 65 or 66 has three terminals 71 to 73 for the connector 65, and three terminals 77 to 79 for the connector 66. The terminals of each female connector 65 or 66 are so distributed geometrically as to be matched to a single male connector installed on each of the electronic modules 61 and 62.

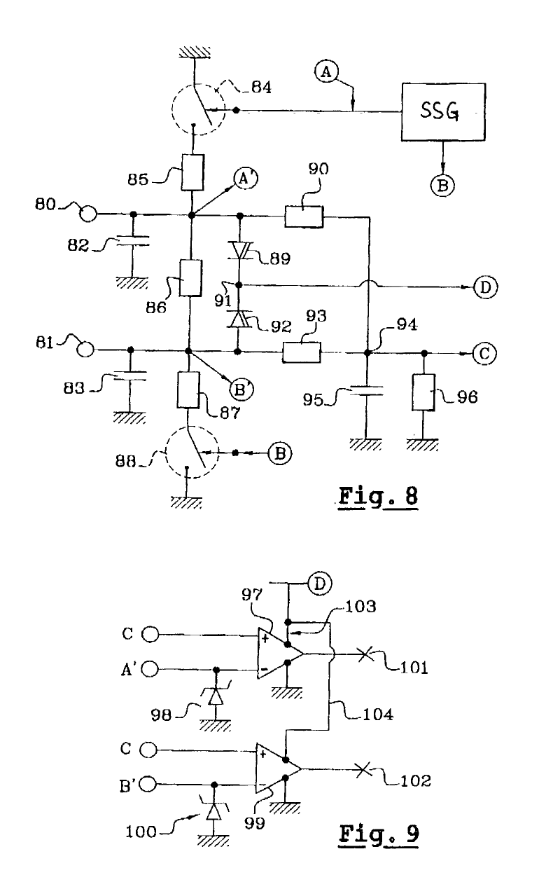

Reference is now made to FIGS. 8 and 9, which show one particular version of a configuration device which is adapted to an electronic module in a network of the kind described above with reference to FIG. 6. In particular, this configuration device is designed here on the basis of a terminal subset associated with a connection to a positive direct current supply voltage. It is clear firstly that, in the case of negative supply, the same device may be used by changing the polarisations, and secondly that, for one signal line, filters enable mean values to be obtained, or enable time frames to be selected, in which a detected positive supply value can be used to perform the same function on a signal line such as the line S.

FIG. 8 shows the two terminals 80 and 81 of the terminal subset from which, firstly, a reconstruction line D is drawn, and secondly, a code 101, 102 shown in FIG. 9 and representing uniquely a part of a code which enables the module to be identified in accordance with the terminal connected between the terminal 80 and the terminal 81. It is clear that the terminals 80 and 81 of the configuration circuit are directly connected to suitable terminals of the appropriate subset on the associated connector of the module.

Each terminal 80 and 81 is connected to ground through a filter capacitor 82, 83 and to points at a potential A′ and B′ which are connected on a ladder (series) of resistors 85, 86 and 87. The point of potential A′ is connected to the anode of the first diode 89, while the anode of a second diode 92 is connected to the node B′. The two diodes 89 and 92 enable a unique reconstructed line D, which is the local positive power supply line for the module, to be produced.

The cathodes of the diodes 89 and 92 are connected together at a node 94 through resistors 90 and 93, while the node 94 is connected to a terminal C which will be made use of in the next following circuit shown in FIG. 9.

The node 94 is also connected to ground through a parallel circuit consisting of a resistor 96 and a capacitor 95.

In this way, during connection of the module on the network, a protected unidirectional voltage is generated which enables a determination to be made as to which of the two terminals 80 or 81 is actually connected. To this end, the series of resistors 85 to 87 is connected to ground at its two free ends through controlled interrupters 84 and 88. In one embodiment not shown in the drawing, only one of the two interrupters 84 or 88 is connected or controlled in the configuration circuit. However, in order to balance the operation of the circuit, in accordance with the supply polarities (especially in the case of a bi-polar supply), it is preferable in this case (with uni-polar power supply on electrical ground) to provide two interrupters 84 and 88.

Each controlled interruptor 84 or 88 is preferably obtained with the aid of a MOS transistor of the N type, with an anti-parallel protection diode between its drain and its source. The grid of the MOS transistor associated with the interrupter 84 is connected to an output A and a selection signal generator SSG. The grid of the MOS transistor associated with the interruptor 88 is connected to an output B.

Activation of each selection signal A or B causes the presence of a supply voltage on the terminal 80 or 81, as the case may be, to be analysed. Thus, when the signal A is active, the circuit of FIG. 8 is connected to ground between the node A′ and the interrupter 84. This results in a first voltage at the node 94 which can later be measured.

If the signal is not connected on the terminal 80, but is connected on the terminal 81, another measurement of voltage at the node C will be obtained by reading the voltage which exists due to closing of the interruptor 88 which connects the node B′ to ground through a resistor 87. This results in a second voltage value which can be detected by the same means.

Another result is that, by detection of the voltages at the node 94, it can be seen whether the battery supply line is connected on the terminal 80 or the terminal 81 in the image of the terminal subset to which the line has previously been connected on the module.

FIG. 9 shows a voltage comparator means of this kind. Here, two operational amplifiers 97 and 99 are connected as voltage amplifiers, with a first positive terminal of each operational amplifier being connected to the node 94 via the point C. The negative second input terminals of each comparator 97 or 99 is connected to the node A′ or the node B′ respectively. Each input terminal is similarly connected to ground through a Zener diode 98 or 100.

The comparison between the voltages thereby enables it to be detected whether the terminal 80 or 81 is connected, by detecting an active logic value, that is to say a code which identifies which module, if any, is connected to the terminal 80 or 81 concerned. These codes are denoted 101 and 102 respectively.

When a plurality of subsets of terminals are connected, the comparator means are connected together through an OR gate, in such a way as to compose a unique identifying word which is characteristic of the electronic module.

In one embodiment, the network also includes a means for detecting, after recognition of the address of the electronic module, a default state on one of the lines of the bus connected to an electronic moduel, by detecting an erroneous identifier of the electronic module. In one version, the positive dc supply and ground terminals are also connected to an electromechanical actuator. In a situation of this kind, the means provided by the invention also enable failure of the actuator to be detected by recognition of the address.

Where an actuator is not connected, the emitter of the network, such as the emitter 50 in the embodiment of FIG. 5, transmits an interrogation signal to the modules. Each module may respond at that moment with the aid of a particular signal which is emitted in accordance with the protocol applied on the network.

If the module is no longer connected, such a response is then impossible and the failure can accoridngly be detected immediately by the central interrogation unit 50.

It will be realised that there is no point in multiplying the lines of the bundle in order to increase the number of modules, but that, on the contrary, it is sufficient to increase the number of terminals on the modules in such a way as to increase the combinations of the various subsets.

Where an electronic module equipped with a configuration circuit according to the invention is connected to the bus of the onboard network having redundant wires as explained earlier herein, addressing of the module is carried out during application of a voltage by an interrogation module of the network controller. Then, during operation of the network, the network controller produces verifications in such a way that the electronic module is interrogated, and responds if it is connected correctly. If a connection becomes faulty, the address of the module changes and in particular may enter into conflict with an address already made, or may take an address which is still free but reserved to another module for another configuration of the network. In order to detect situations of this kind, the network controller is equipped wtih a module for detecting the constancy of the address of each electronic module connected to the bus of the network that retains the memory of the addresses of the electronic modules already connected, and, if necessary, the address reserved for electronic modules in other configurations of the network.

It will also be observed that, in accordance with the invention, the fact of connecting a new electronic module, or an additional electronic module, is enough for the network to recognise the new address, through its network controller, from the time that voltage is applied, without any procedure for address attribution being carried out by the network controller. The latter causes only the detection of any addresses which are invalid or in conflict as discussed above. In this way, the procedures, often rather tricky, for determining addresses which are known in the present state of the art are avoided.

It will further be noted that the bus may easily be standardised without it being necessary for the electronic modules with which it is to operate to be all provided in advance. It is enough that the redundancy of the lines of the bus and the configuration techniques employed in the configuration circuit of the invention enable an additional number of addresses to be realised so as to add new modules. Thus, in a vehicle, a single bus may be designed and installed on all the models of any particular marque, or of a range of vehicles of that marque. Depending on what options are chosen by the builder of the vehicle, each model of the marque or range concerned will be equipped with the desired number and chosen type of electronic modules, each equipped with the appropriate configuration circuit.

What is claimed is:

1. A configuration device for an electronic module, for connection in a network of the type having a multiplexed bus having a plurality of lines, wherein the configuration device comprises:
a connector having, for at least one said line of the multiplexed bus, a predetermined number of terminals including at least one subset of terminals, with only one said subset being arranged for connection to the said bus line;
a reconstituting circuit for reconstituting the line connected to the said subset and for connecting it to the remainder of the said module;
a circuit for detecting the relative positions of the said terminals connected in the said subset; and
an identifier generating circuit for generating a unique digital data item on the basis of detection of the relative positions of the connected terminals, whereby the said data item is an identifier for the electronic module.

2. A device according to claim 1, wherein the reconsituting circuit comprises a combining circuit having a plurality of inputs and a single output, the combination circuit including diodes for protecting the inputs, and being adapted to combine the inputs in a single output.

3. A device according to claim 1, further including a selection signal generator, the reconstituting circuit having a plurality of inputs, the identifier generating circuit having a plurality of inputs, the device further including a bus connecting the selection signal generator to selected inputs of the reconstituting circuit and identifier generating circuit, and also including an internal bus connecting the said terminal subset of the connector with the reconstituting circuit and the identifier generating circuit, the selection signal generator including means for scanning different input terminals of the said subset by putting successive lines of the said internal bus at a reference potential whereby to interrogate each terminal in turn so as to detect whether the said terminal is really connected to the bus line, the device further including means for generating a succession of binary signals indicating by their state whether the interrogated terminal is so connected, and means for generating, from the said binary signals, a unique digital identifier identifying the relevant electronic module.

4. A device according to claim 2, having at least two said subsets, each connected to a respective said identifier generating circuit, the said identifier generating circuits together defining a logic combination constituting a general identification parameter generator including an OR logic element, whereby to produce a binary word uniquely representing the address of the associated electronic module in the network.

5. A device according to claim 1, wherein each said module includes a first said connector having a plurality of first terminals, the device having a reciprocal second connector for connection to the multiplexed bus of a said network, the said reciprocal second connector comprising a plurality of second terminals, such that the said second terminals are disposed in a geometric pattern matching only one said first connector.

6. A device according to claim 2, further including a first signal terminal and a second signal terminal, a filter capacitor connecting said first and second signal terminals to ground, the device having circuitry including: the said circuits and signal terminals; a series of first resistors defining a first potential defining node and a second potential defining node; a first diode having an anode connected to the first node; and a second diode having an anode connected to the second node, the diodes having cathodes which are connected to a common third node, whereby the diodes enable a unique reconstructed line to be produced at the third node.

7. A device according to claim 6, wherein the circuitry further defines a fourth node, and includes: the first anode and the fourth node; a third resistor connected between the second anode and the fourth node; a parallel circuit connecting the fourth node to ground, the said parallel circuit comprising a resistor and a capacitor; two operational amplifiers, connected together and defining a first voltage comparator and a second voltage comparator for generating a unique output code in the form of a logic quantity, each comparator having a first positive terminal connected to the fourth node, and further having a negative second input terminal, the said second terminal of the first comparator being connected to the said first node and that of the second comparator to the second node; a first Zener diode; and a second Zener diode, the negative second input of each of the comparators being connected to ground through the said first and second Zener diodes respectively, whereby to perform a voltage comparison to determine, by detection of the appropriate said output code, whether either of the said signal terminals is connected.

8. A device according to claim 6, further including first and second controlled interrupters, each connecting a respective free end of the said series of resistors to ground, the device further including a selection signal generator, at least one said controlled interrupter being connected to the said selection signal generator.

9. A network with a multiplexed bus of a plurality of lines, the network including a plurality of electronic modules each including a configuration device according to claim 1, wherein the multiplexed bus has a redundancy of lines such that the address of each said module is defined by the pattern of connection of the module to the said bus, the said address being recognised locally by the configuration device of the module.

10. A network according to claim 9, further including means for detecting, after recognition of the address, a failure state on one line of the bus connected to a said module, by detecting an erroneous identification code.

11. A network according to claim 9, further including a network controller comprising a module for detecting constancy of the address of each said module connected to the network bus which memorises the addresses of the said modules already connected and, where appropriate, the address reserved for electronic modules for further configurations of the network.

12. A network according to claim 9, wherein the said network bus is constructed as a flexible circuit comprising a flexible insulating substrate and a plurality of conductive tracks carried on the substrate, the said tracks comprising a plurality of supply lines and multiplexed signal lines with some redundancy, each electronic module of the network being equipped with a configuration circuit and having a connector, each said module being connected with the network bus through the said connector, each said connector having a plurality of terminals, the said flexible circuit further including eyelet-type rivets whereby each terminal of the said connector is connected to at least one polarity or signal type through a said rivet.

13. A network according to claim 12, wherein the configuration circuit of each electronic module includes a circuit for detecting what line or terminal is connected to any of the said lines of the flexible circuit, given that a single element selected from the group consisting of a line or terminal of one polarity and a line or terminal of one signal type where there are a plurality of signal types on the bus, is connected to the said module.

14. A network according to claim 13, wherein the configuration circuit further includes means for detecting the number of terminals connected to said elements, whereby to increase the number of modules able to be connected in the network with a unique address.
